(19) United States
(12) Patent Application Publication
(10) Pub. No.: US 2016/0335700 A1
(43) Pub. Date: Nov. 17, 2016

(54) SHOPPER-CENTRIC SOCIAL NETWORKING SYSTEM

(71) Applicant: Alexei Fomine, Houston, TX (US)

(72) Inventor: Alexei Fomine, Houston, TX (US)

(21) Appl. No.: 14/474,098

(22) Filed: Aug. 30, 2014

(51) Int. Cl. G06Q 30/06; G06F 3/0482; H04L 29/08; G06F 17/30; G06Q 30/02

(52) U.S. Cl. CPC G06Q 30/0631; G06Q 30/0633; G06F 17/30867; G06Q 30/0277; H04L 67/306; G06F 3/0482; G06Q 50/01

(57) ABSTRACT

Disclosed is a shopper-centric social networking system. The system comprises a user interface, a user database comprising a plurality of user entries wherein, each user entry represents a user registered therewith, each user entry associated with a plurality of friend entries wherein, a friend entry represents a fellow registered user who is friends with the registered user, each user entry further associated with a plurality of purchase order entries wherein, a purchase order entry represents a purchase order placed by the user on a merchant site, a purchase order defined by a plurality of purchase order attributes comprising the date and time of purchase, the identity of the product purchased, the brand of the product purchased, the identity of the merchant site from which the product has been purchased, the product category of the product purchased, the product rating awarded by the customer, and a purchase orders settings module for enabling a user to allow select friends thereof to access select purchase orders made by the user via the user interface.

### BACKGROUND

1. Field of the Invention

The present invention relates to social networking and more particularly to a shopper-centric social networking system.

There's no denying that product reviews are instrumental in the market success or failure of a product. The fact that every product that is sold by an online retailer is associated with user ratings only affirms the earlier statement. Therefore, today, it is very common to see people verify user reviews before purchasing any product. However and unfortunately, seasoned online shoppers understand that many of those ratings are not genuine and there is no way to verify how many of those ratings are true and posted by genuine reviewers, i.e., non-paid product reviewers. To further prove the point, there are now online services, or gigs, offered by advertisers to post a “positive” review about any product just for money thereby further discrediting the entire online product rating and review system. Therefore, in the light of all of this, it can be inferred that, when it comes to making a purchase decision, it is better to trust a review from a known source, such as a friend, than from a stranger passing off as an expert in the non-verifiable virtual world.

Therefore, in the light is what is discussed above, there is a need in the art for a solution for the aforementioned trust issue.

### SUMMARY

The present invention comprises a shopper-centric social networking system, which is simply an extension of a social networking system. Basically, the social networking element serves users to make better purchase decisions based on friends' product reviews. The system of the present invention comprises a user interface for enabling a user to interact therewith, a user database comprising a plurality of user entries wherein, a user entry represents a user registered therewith. Each user entry is associated with a plurality of friend entries wherein, each friend entry represents a fellow registered user who is friends with the registered user. The user database is disposed in operative communication with a plurality of merchant servers wherein, a merchant server represents a participating merchant or online retailer where the user holds a membership account. As the user database is associated with the plurality of merchant servers, each user entry is associated with a plurality of purchase orders placed by the user on the merchant site as a customer. The system is adapted such that, the user enabled to access the purchase orders of his/her friends.

The system comprises product and merchant rating modules, each of which enabling a user to rate and review a product and the merchant from which the product has been purchased respectively. Each purchase order of the user is associated with comprising exemplary “rate the product” and “rate the merchant” hyperlinks or buttons, which are deployable via the user interface. Selecting the aforementioned buttons directs the user to rating screen where the user is prompted to leave a rating, once and for all, for the product as well as the merchant. Once the inputs are inputted, each purchase order of the user is associated with those ratings, which helps helping friends in making better purchase decisions such as, which product to buy, where to buy, etc.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is a schematic block diagram of the shopper-centric social networking system.

FIGS. 2A through 2C, according to an embodiment of the present invention, are exemplary sequential screenshots involved in registering the user.

FIGS. 3A and 3B, according to an embodiment of the present invention, are exemplary sequential screenshots involved in creating a user profile.

FIG. 4, according to an embodiment of the present invention, is an exemplary screenshot of the form for inputting merchant login details.

FIGS. 5A and 5B, according to an embodiment of the present invention, are exemplary sequential screenshots involved in rating a product.

FIGS. 5A and 5C, according to an embodiment of the present invention, are exemplary sequential screenshots involved in rating a merchant.

FIGS. 6A and 6B, according to an embodiment of the present invention, are exemplary sequential screenshots of main and supplementary update screens respectively displaying restricted and expanded product order updates respectively from friends.

FIGS. 7A through 7C, according to an embodiment of the present invention, are exemplary sequential screenshots involved in categorically restricting the visibility of one's purchase orders.

FIGS. 8A and 8B, according to an embodiment of the present invention, are exemplary screenshots involved in masking and unmasking product orders respectively.

FIGS. 9A through 9C, according to an embodiment of the present invention, are exemplary sequential screenshots involved in categorically restricting the visibility of friends' purchase orders on the main updates screen.

FIGS. 10A through 10E, according to an embodiment of the present invention, are exemplary sequential screenshots involved in requesting a sale of a product purchased by a friend.

FIGS. 11A and 11B, according to an embodiment of the present invention, are exemplary sequential screenshots involved in endorsing a friend.

FIGS. 12A through 12C, according to an embodiment of the present invention, are exemplary sequential screenshots involved in the operation of a pre-purchase advice module.

FIG. 13, according to an embodiment of the present invention, is an exemplary screenshot of a friend's purchase orders associated with wishlist module.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

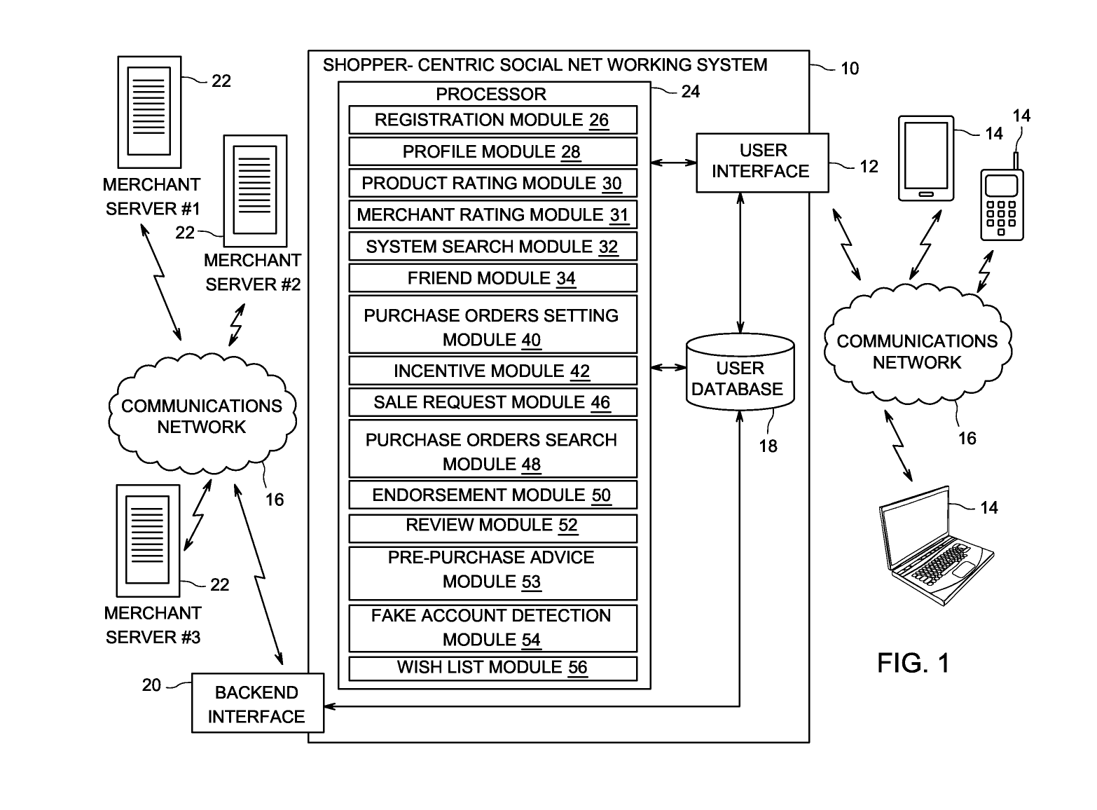

Embodiments of the present invention are directed to a shopper-centric social networking system that, apart from enabling users to virtually socialize with one another, as known in conventional social networking sites such as, Facebook®, LinkedIn®, etc., assists users in making better purchase decisions. Referring to FIG. 1, the system 10 comprises a user interface 12 for enabling a user to interact therewith. The user interface 12, which is provided by a website, a dedicated computer application, or the like, is facilitated by remote user terminals 14 such as, desktop computers, laptop computers, notebook computers, tablet computers, mobile phones, cellular phones, PDAs, etc., that capable of transacting data over a communications network 16, such as, the Internet, or the like. The user interface 12 further comprises a main updates screen and a supplementary updates screen wherein, the utility of both of which will become apparent from the following body of text.

Referring to FIG. 1, the system 10 further comprises a user database 18, which is disposed in operative communication with the user interface 12. The user database 18 comprises a plurality of user entries. Each user entry represents a user registered therewith wherein, the process for registering a user will become apparent from the following body of text. Each user entry is associated with the profile information thereof, which typically includes the full name, contact information, education, employment, interests, hobbies of the user, etc. Each user entry is further associated with a plurality of friend entries wherein, a friend entry represents a fellow registered user who is “friends” with the corresponding registered user. In other words, a friend is a fellow registered user (of the corresponding registered user), whose profile is associated with that of the corresponding registered user. Notably, the registered user will hereinafter simply be referred to as the “user”, while the fellow registered user, who is friends with the “user”, will hereinafter be simply referred to as the “friend”.

Referring to FIG. 1, further, the user database 18, via a backend interface 20 and over a communications network 16, is disposed in operative communication with a plurality of merchant severs 22, wherein, a merchant server 22 pertains to the server of a participating online retailer or an online merchant site (or simply, a participating online merchant). In one embodiment, the merchant may comprise a non-virtual or a brick and mortar merchant. In an additional embodiment, a merchant server 22 may be an intrinsic part of the system 10 itself. As the user database 18 is associated with a plurality of merchant servers 22, the purchase orders placed by the customers on the merchant sites, who also happen to be the users (i.e., the registered users) of the system 10, are received within the user database 18 and associated with the corresponding user entries. In other words, by virtue of the user database 18 being disposed in operative communication with the plurality of merchant servers 22, each user entry is further associated with a plurality of purchased orders that are placed by the user on the merchant sites as a customer thereof. Each purchase order that is associated with a user entry is defined by a plurality of purchase order attributes comprising the date and time of purchase, the order number of the purchase order, the identity of the product purchased, the brand of the product purchased, the identity of the merchant site from which the product has been purchased, the product category of the product purchased, the product rating awarded by the customer. In one embodiment, the purchase order attributes comprises a transaction ID, which represents the transaction number tying the corresponding product and the amount equivalent to the purchase price of the corresponding product that is debited from the user's credit card or bank account.

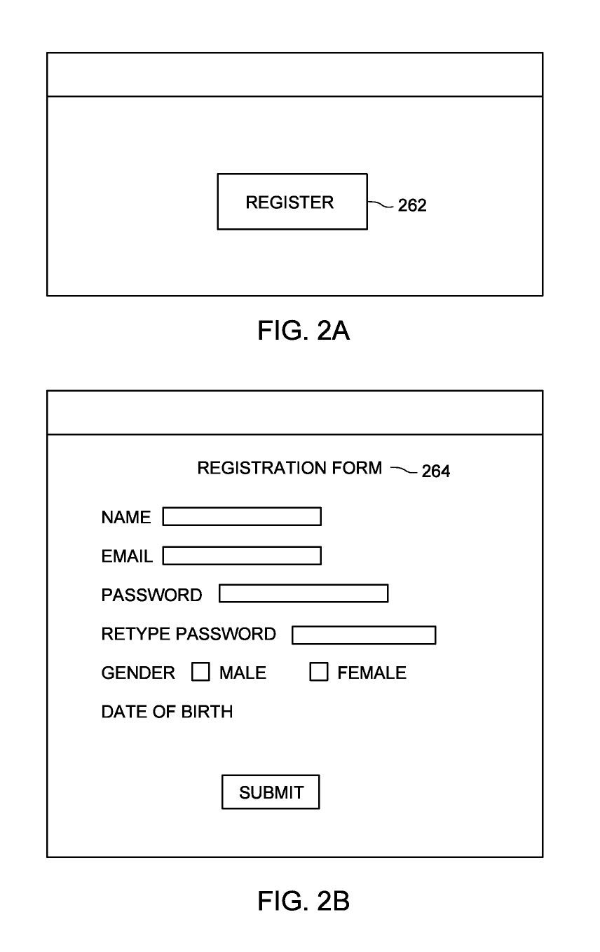

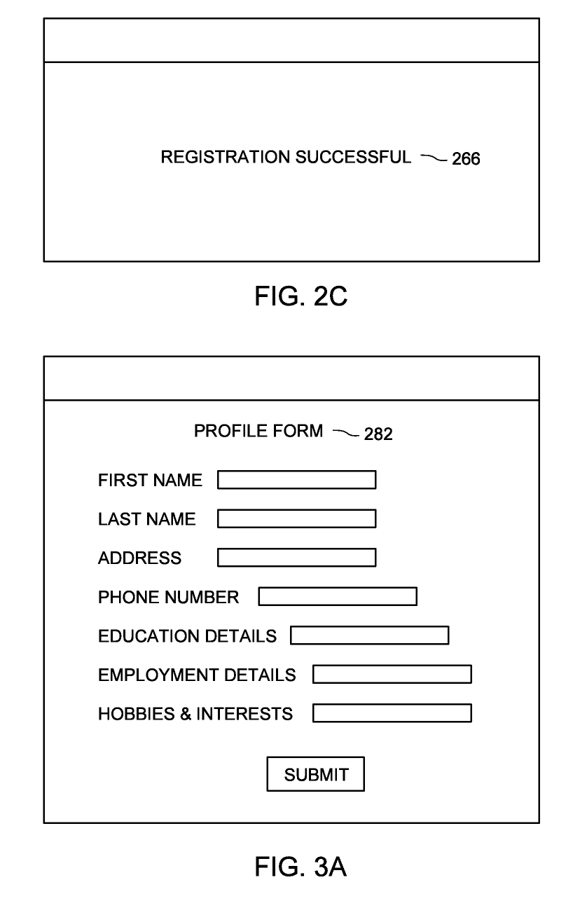

Referring to FIGS. 1 and 2A through 2C, the system 10 further comprises a processor 24 disposed in operative communication with the user interface 12 and the user database 18. The processor 24 comprises a plurality of processing modules comprising a registration module 26, a profile module 28, a product rating module 30, a system search module 32, a friend module 34, a purchase orders settings module 40, an incentive module 42, a sale request module 46, a purchase orders search module 48, an endorsement module 50, a review module 52, a pre-purchase advice module 53, a fake account detection module 54, and a wishlist module 56.

Still referring to FIGS. 1 and 2A through 2C, the registration module 26, which enables a user to become a registered user of the system 10, comprises a “registration” initiator deployable by a user via the user interface 12. More particularly, as seen in FIG. 2A, the registration initiator comprises a registration hyperlink 262 or, in other words, an exemplary “registration” button 262 wherein, selecting the registration hyperlink 262 results in the user being directed to a registration form 264 for receiving registration details from the user such as, the name, email address, password, gender, the date of birth of the user, etc. Once the registration details are ‘submitted’, the details are parsed for errors. If it is determined that the registration details are not in keeping with a predetermined syntax or if there are any missing registration input fields and therefore are invalid, the registration form is re-delivered to the user prompting him/her to re-enter the registration details. However, on the other hand, if the registration details submitted are determined to be valid, an exemplary ‘successful registration’ message 266 is delivered to the user via the user interface 12 indicating that the user is now a registered user.

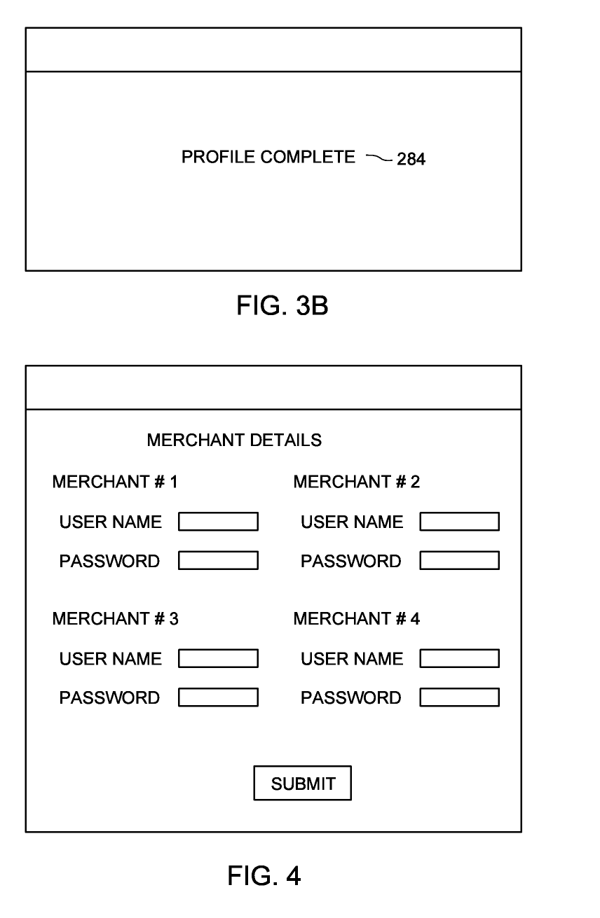

Referring to FIGS. 1, 3A and 3B, once the user is a registered member, as enabled by the profile module 28, he/she is prompted to enter his/her profile details within a profile form 282, which include standard profile details such as, the first and the last name, full contact information including the address and phone number(s), education, employment, interests, hobbies, etc., as particularly seen in FIG. 3A. Once the profile details are ‘submitted’, the profile details are parsed for errors. If it is determined that the profile details are not in keeping with a predetermined syntax or if there are any missing profile input fields and therefore are invalid, the profile form is re-delivered to the user prompting him/her to re-enter the profile details. However, on the other hand, if the profile details that are submitted are determined to be valid, as seen in FIG. 3B, an exemplary ‘user profile complete’ message 284 is delivered to the user via the user interface 12.

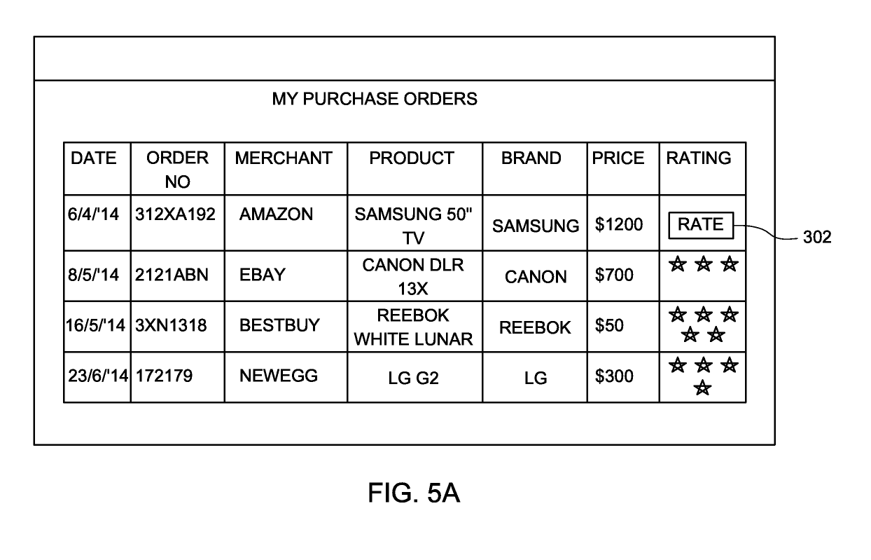

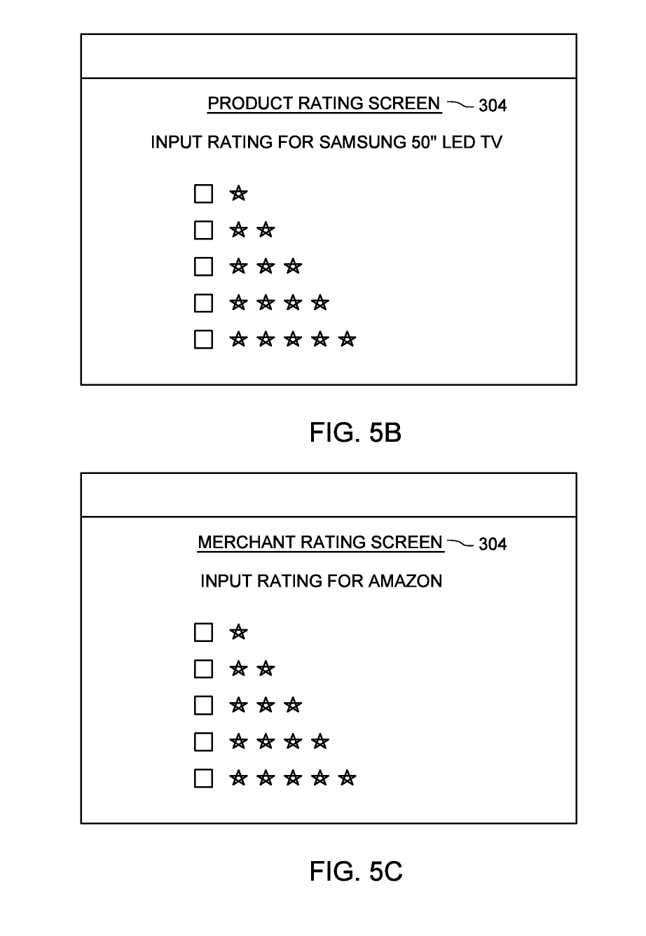

Referring to FIGS. 4, and 5A through 5C, additionally, the user is prompted to input his/her login details of the merchant sites where he/she holds a membership account as seen in FIG. 4. Once the login details are received and validated, the purchase orders made by the user in the merchant sites are retrieved and are associated with the profile of the user. Notably, the login details of the merchant sites are stored within in the user database 18 so that, the purchase orders of the user are automatically synchronized into the user database 18 every time the user logs into the system 10. Preferably, the purchase orders are adapted to be sorted chronologically, by ascending or descending order of the prices, etc. As seen in FIG. 5A, each purchase order of the user is associated with the aforementioned product rating module 30 comprising an exemplary “rate the product” hyperlink or button deployable by the user via the user interface 12. The user, upon selecting the “rate the product” hyperlink, is prompted to, once and for all, input a rating for the corresponding product within a rating screen delivered to the user as seen in FIG. 5B. Similar to product rating, as can be appreciated from FIG. 5A, each purchase order of the user is further associated with the aforementioned merchant rating module 31 comprising an exemplary “rate the merchant” hyperlink or button deployable by the user via the user interface 12. The user, upon selecting the “rate the merchant” hyperlink, is prompted to, once and for all, input a rating for the corresponding merchant within a rating screen delivered to the user as seen in FIG. 5C. In one embodiment, each of the product and merchant rating screens further comprises a comments section for enabling the user to input additional comments on the product and merchant respectively wherein, the inputted additional comments are adapted to be accessible to friends accessing the corresponding purchase order.

Referring to FIG. 1, in one embodiment, the system 10 comprises a low product rating module (not shown), which is a part of the product rating module 30 wherein, when a product is awarded a low rating by the user in the aforesaid manner, the user's rating is communicated to the manufacturer of the corresponding product. Further, the system 10 is configured such that, the manufacturer is enabled to establish contact with the user in order to solicit more detailed feedback so as to know the reason behind the low product rating. In one embodiment, the system 10 comprises a low merchant rating module (not shown), which is a part of the merchant rating module 31 wherein, when a merchant is awarded a low rating by the user in the aforesaid manner, the user's merchant rating is communicated to the merchant of the corresponding product. Further, the system 10 is configured such that, the merchant is enabled to establish contact with the user in order to solicit more detailed feedback so as to know the reason behind the low merchant rating. For example, if a user purchases a 50″ Samsung TV from FRY's Electronics and leaves one star rating to FRY's and two stars rating to Samsung, the same is communicated to FRY's and Samsung respectively so that, they can contact the user directly via the system 10. In one embodiment, a “low rating” may be preset by the merchant and manufacturer such as, for example, a low rating is considered as something below or equal to two stars, three stars, etc. In one embodiment, each product order may be associated with the interactions between the user and the merchant or manufacturer, or both such that, they may be visible to the friends of the user.

Referring to FIG. 1, the aforementioned system search module 32 comprises a system search bar for receiving keywords therewithin via the user interface 12. Once the keywords are “submitted” by the user, the system search module 32 is adapted to parse the entire user database 18 for results that match the keywords. Upon match, the system search results are delivered to the user, preferably in a sorted manner. This helps the user in finding friends, topics of interest, items purchased by friends, etc. As enabled by the friend module 34, each fellow registered user's profile (or profile page) is associated with an exemplary “add as friend” button wherein, selecting the “add as friend” button associates the profile of the fellow user with that of the user making the user friends with his/her fellow user. The system 10 is adapted such that, any developments in the friend's profile is communicated to the user on the aforementioned main updates screen. Examples of updates include the friend making a new friend, updating his/her profile information, rating a product, etc. Further, the system 10 is adapted such that, the user may access the friend's purchase orders and vice versa. Further, the system 10 is adapted such that, any purchases made by the friend is also updated on the main updates screen.

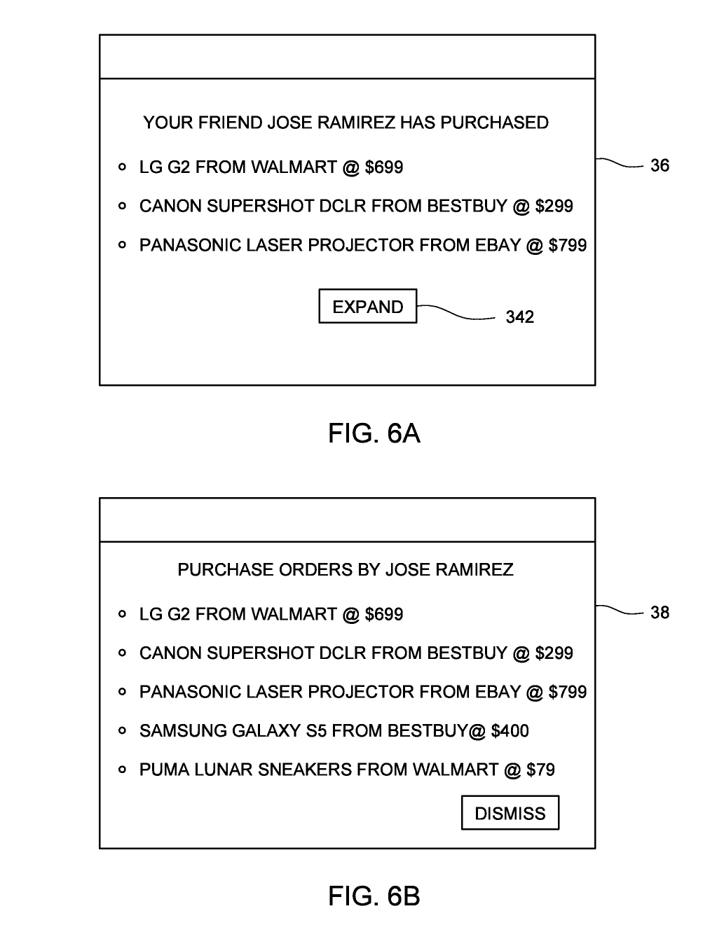

Referring to FIGS. 1, and 6A and 6B, in one embodiment, as seen in FIG. 6A, the system 10 is adapted such that, only a predetermined number of purchase orders placed by the friend are updated on the main updates screen 36. Such a restricted update is further associated with an exemplary “expand” 342 button wherein, selecting the expand button 342 directs the user to a supplementary updates screen 38 where all the updates are listed thereon as seen in FIG. 6B. In one embodiment, each update, whether on the main or supplementary updates screen, is associated with a “thumbs up” and a “thumbs down” button wherein, the user's selection of the thumbs up button indicates the user's appreciation of the corresponding update and the user's selection of the thumbs down button indicates the user's disapproval of the corresponding update. In one embodiment, each update, whether on the main or supplementary updates screen, is associated with a “comment” button wherein, the user selecting the comment button opens up a text input section where, the user is enabled to input generally his/her comments related to the corresponding update. In one embodiment, each comment posted by the user is associated with a “reply” button wherein, the friend selecting the reply button opens up a text input section where, the friend is enabled to input generally his/her comments related to the corresponding comment or comments. In one embodiment, each replied text is associated with a similar “reply” button so as to enable the friend and the user to continue the conversations in the aforesaid manner. In one embodiment, each update is associated with an exemplary “save” or “hide” button wherein, the user, upon selecting the save button, the corresponding update is moved to an exemplary “my saved friend updates” section for future reference.

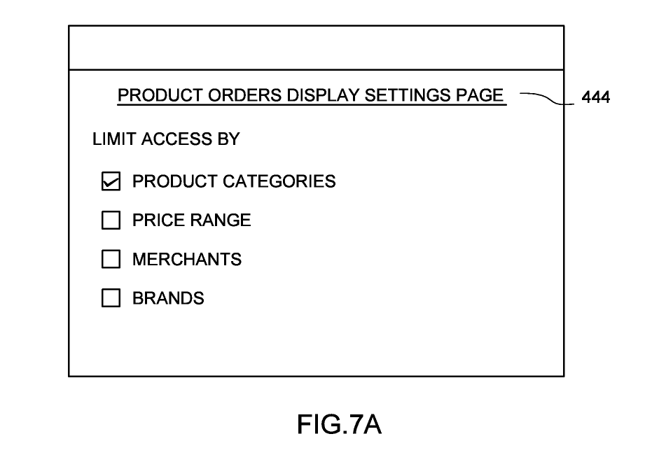

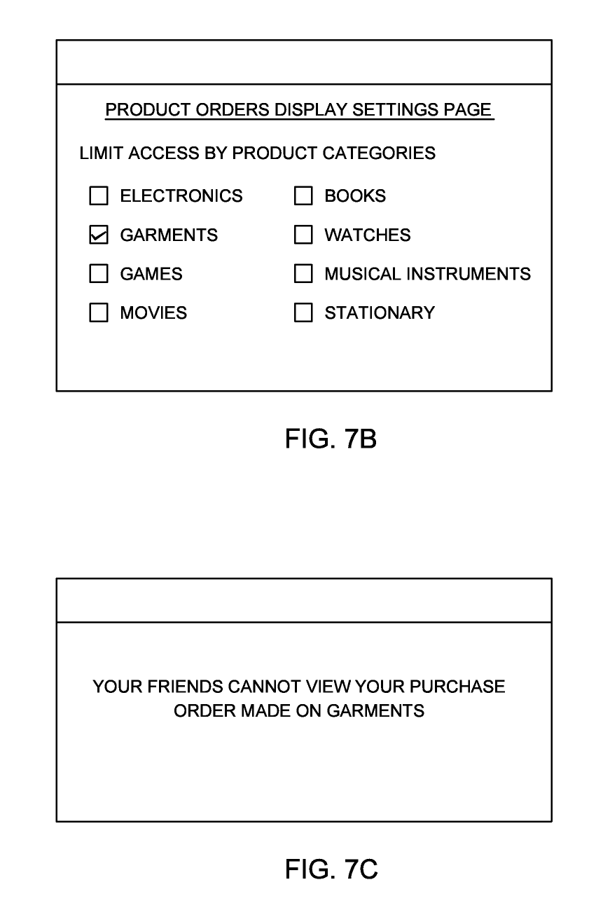

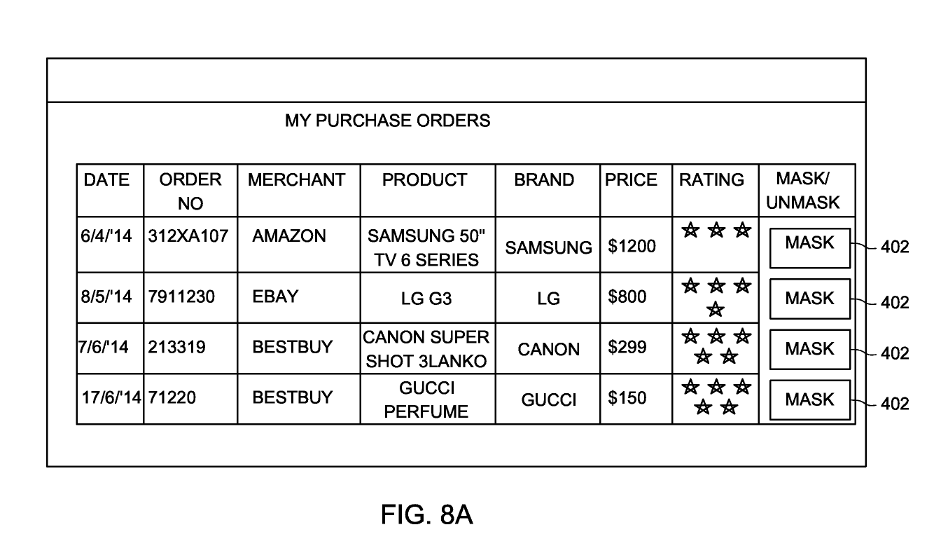

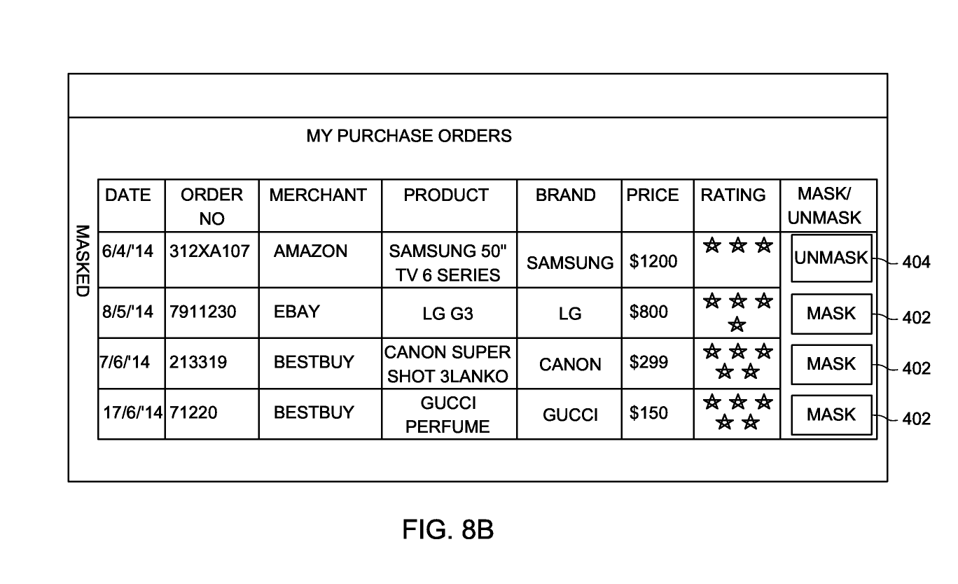

Referring to FIGS. 1, 7A through 7C, and 8A and 8B, the aforementioned purchase orders settings module 40 enables the user to categorically limit (or prevent) the access of his/her purchase orders by his friends by product category or categories, the merchant or merchants from which the product has been purchased, the brand or brands of the product, and the price or the price ranges of the product, or a combination thereof, as seen on the product orders access settings page shown particularly in FIG. 7A. For example, as seen in FIG. 7B, if the user has restricted access to products pertaining to garments category, the friends thereof cannot access the user's purchase orders that pertain to the garments category as seen in FIG. 7C. Additionally, the system 10 enables the user to restrict or block select friends thereof from accessing his/her purchase orders. In addition to limiting the purchase orders in the aforesaid manner, the system 10, as enabled by the purchase orders settings module 40, is adapted to enable the user to limit the friends thereof from accessing his/her purchase orders individually. More particularly, as seen in FIG. 8A, each purchase order of the user is associated with an exemplary “mask” button 402 wherein, selecting the mask button 402 causes the corresponding purchase order to be only accessible by the user himself/herself. In one embodiment, as seen in FIG. 8B, a masked or restricted purchase order (including the purchase orders that are earlier limited categorically) is associated with an exemplary “unmask” button 404 wherein, selecting the unmask button 404 reverses the aforementioned masking effect. Preferably, the mask and unmask buttons 402 and 404 are embodied within one button as a toggle button.

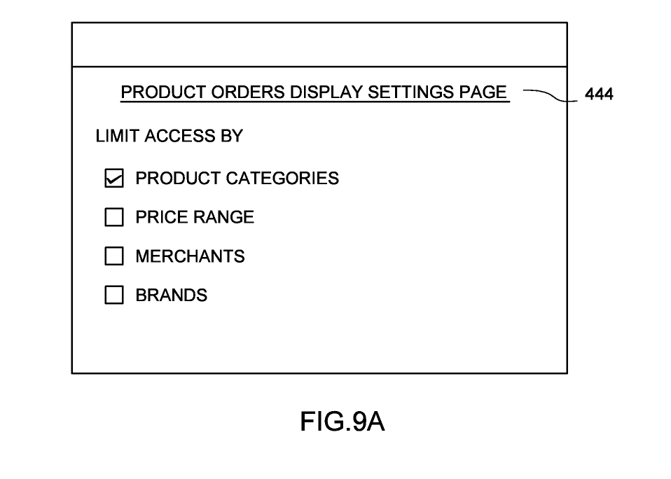

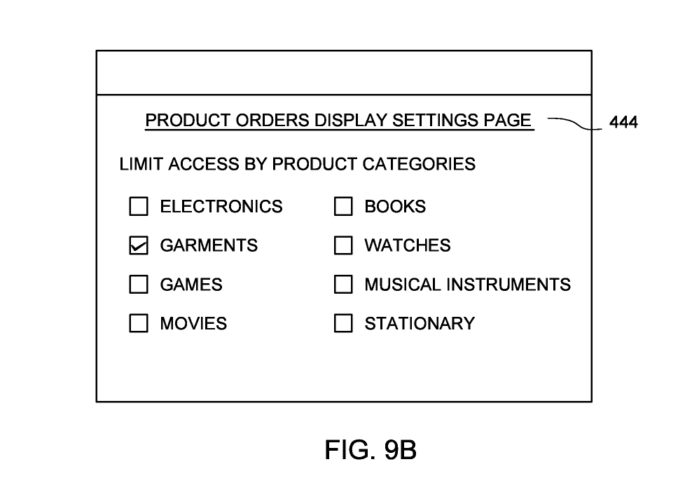

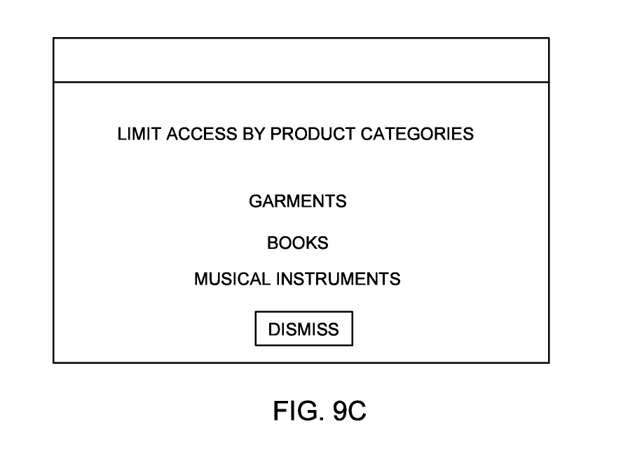

Referring to FIGS. 1, and 9A through 9C, as the user's purchase orders are restricted by the user in the aforesaid manner, the purchase orders settings module 40 also enables the user to restrict (or limit) the friends' purchase orders that are updated on the main updates screen. More particularly, the friends' orders can be restricted categorically by product category or categories, the merchant or merchants from which the product has been purchased, the brand or brands of the product, and the price or the price ranges of the product or a combination thereof. For example, if the user has restricted access to products pertaining to the garments, books, and musical instruments category, then the system 10 is adapted such that, the main updates screen doesn't display friends' purchase orders that pertain to the aforementioned categories as exemplarily displayed by the message in FIG. 9C.

Referring to FIG. 1, in one embodiment, a supplementary updates screen comprises a chance-based virtual game such as, the spinning slot wheel, or the like, for encouraging the user to visit the supplementary updates screen on a regular basis wherein, winning the game results in the user being awarded a shopping incentive such as, a discount coupon, or the like. In another embodiment, the system 10 comprises an incentive module 42 comprising a calculation module for calculating the number of times the user has accessed a supplementary updates screen.

The incentive module 42 further comprises a generation module for generating a shopping incentive, such as, a discount coupon, or the like, in keeping with the calculation earlier performed by the calculation module. The shopping incentive is then of course delivered to the user via the user interface 12. In one embodiment, the shopping incentive is adapted to be transferrable to friends. In one embodiment, a shopping incentive, such as, a discount coupon, is awarded to the user if the user has shared a predetermined number of purchase orders (i.e., the purchase orders that are not restricted or limited) to his/her friends. In another embodiment, a shopping incentive, such as, a discount coupon, is awarded to the user if the user's shared purchase orders exceed a predetermined amount of monetary value. In one embodiment, instead of or in addition to receiving shopping incentives, the user, who has exceeded the predetermined purchase orders in terms of the number or monetary value, is awarded a virtual achievement display badge such as, power shopper, super shopper, etc.

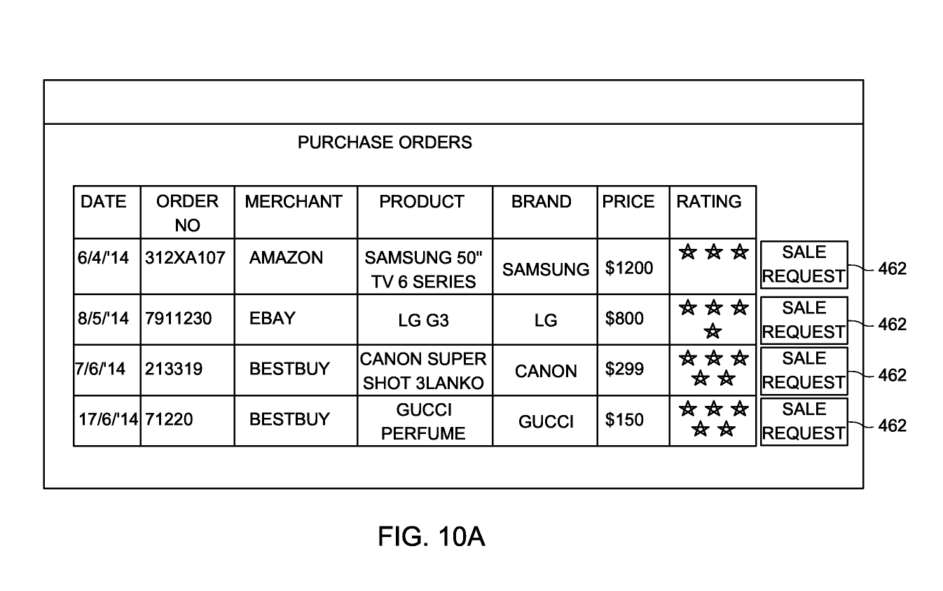

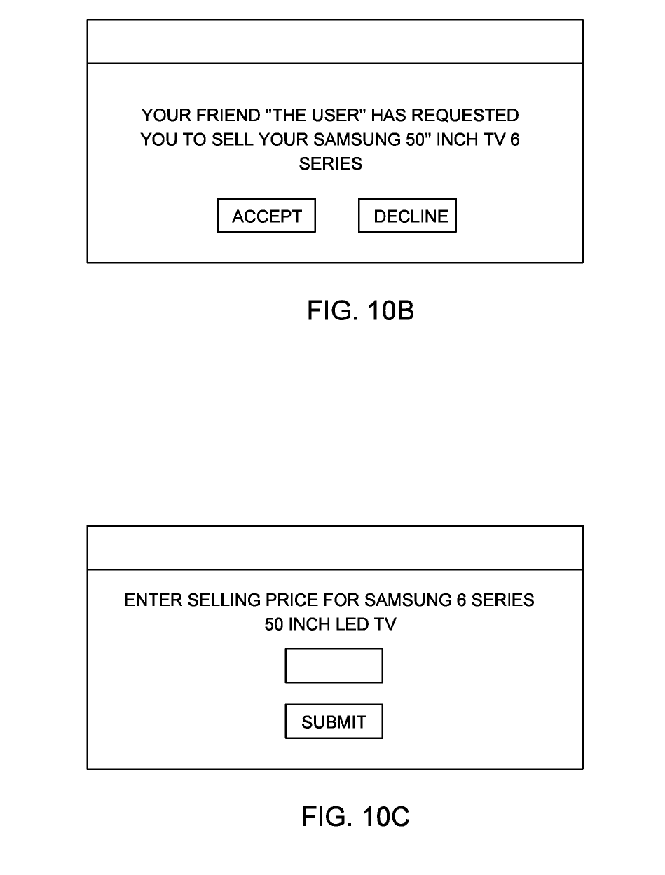

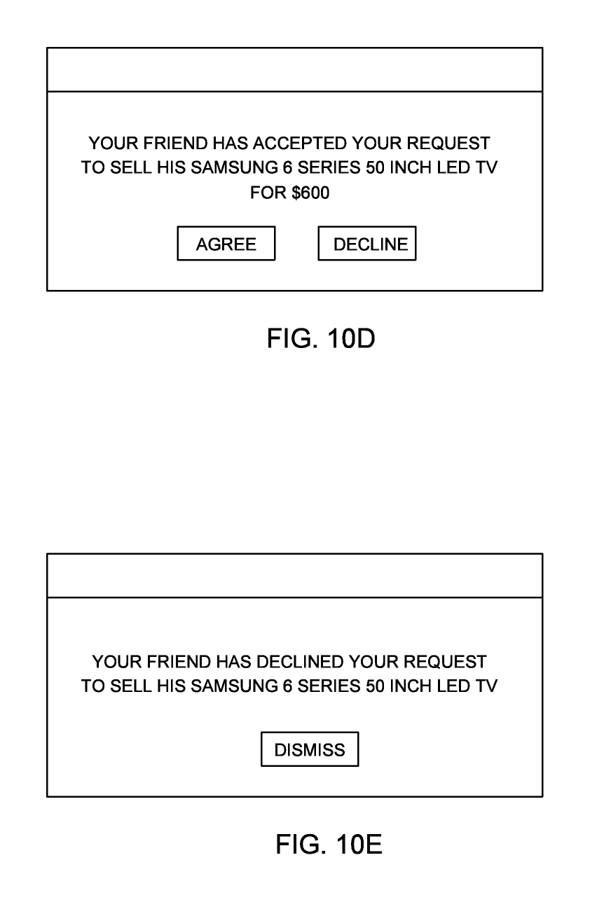

Referring to FIGS. 1, and 10A through 10E, as enabled by the aforementioned sale request module 46, each of the friends' purchase orders is associated with an exemplary “request sale” initiator 462 or button wherein, the user selecting the said button delivers a sale request screen prompting the friend to either accept or decline the user's request for sale of the corresponding product as exemplarily shown in FIG. 10B. The friend, upon selecting the accept button, he/she is prompted to enter the selling price of the corresponding product as exemplary shown in FIG. 10C. Upon the friend's acceptance for sale, the same is communicated to the user along with the selling price quoted by the friend as seen in FIG. 10C. As seen in FIG. 10D, the user, upon being satisfied with the selling price quoted by the friend may select the accept button furthering the deal. On the other hand, if the user is not satisfied with the quoted price, the user may express his denial by selecting on the decline button. On the other hand, if the friend has declined the user's request, the same is communicated to the user as seen in FIG. 10E. In one embodiment, the additional input field may be incorporated along with the accept/decline messages for receiving any additional comments generally related to the product. The additional comments, if inputted by the friend, are communicated to the user along with the friend's acceptance. For example, upon declining the selling quoted by the friend, a counter offer may be proposed by the user by way of entering comments in the additional comments field or entering a counter offer price in a specialized field such as a counter offer field.

Referring to FIG. 1, the aforementioned purchase orders search module 48 comprises a purchase orders search bar for receiving keyword or keywords therewith. Once the keywords are received, the purchase orders search module 48 is adapted to find matches for the keyword or keywords only within the friends' purchase orders that are accessible to the user. The purchase orders search module 48 comprises a retrieval module for retrieving and displaying the search results to the user. For example, the user may input a 50-inch television into the search bar and receiving the purchase orders of friends reflecting the purchase of 50-inch televisions and they may proceed to obtain a sale request of the purchased TV.

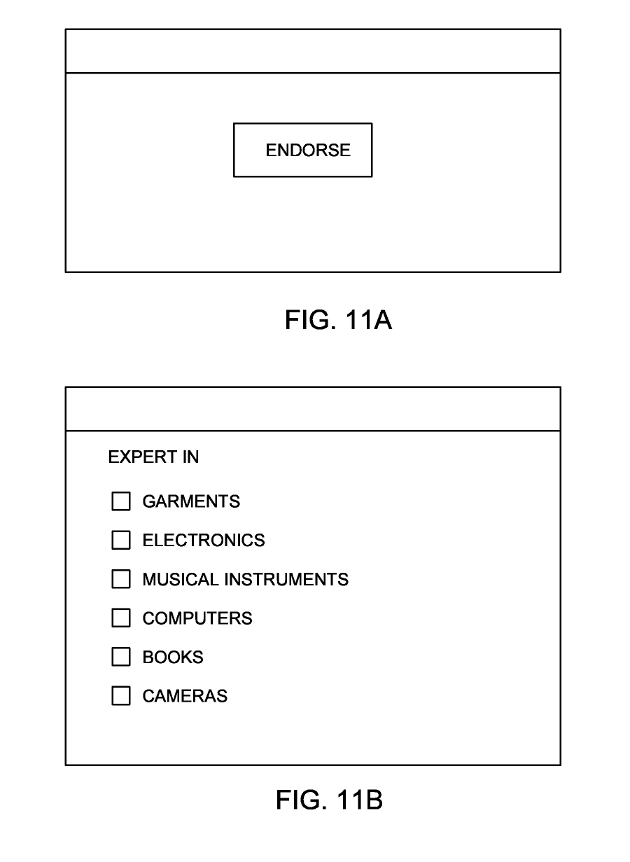

As some of the friends of the user are knowledgeable and as some of them aren't, it may become harder for the user to understand which friends to trust with product reviews and whose opinion carries the most value. The aforementioned endorsement module provides a way for all users to rate and endorse their friends based on their knowledge on any particular product or service. Referring to FIGS. 1 and, 11A and 11B, the aforementioned endorsement module 50 comprises an “endorse” button 502 associated with the profile of each friend as exemplarily shown in FIG. 11A. The user, upon selecting the endorse button 502, opens up a product category page (as exemplarily shown in FIG. 11B) displaying a plurality of product category options wherein, selecting an option or options thereamong implies that the friend is an expert in the corresponding product category field or fields respectively. For example, if the user has selected “electronics”, then it implies that the user has endorsed the friend as an expert in the product category of electronics. As a result, all of the user's friends will now see that “endorsed” friend is a trusted source of reviews.

Referring to FIG. 1, the user database 12 further comprises a plurality of merchant entries wherein, each merchant entry represents a merchant pertaining to an online merchant site associated with the system 10. By virtue of the review module 52, a merchant may approach a user, who, preferably, has most expert endorsements, and request him/her to review a product, sometimes in exchange for a fee. In this event of the user reviewing a product in exchange for a fee, then the review should indicate that the product reviewed is a paid review. In one embodiment, the merchant is required to pay a service fee to towards the system if the user has accepted the offer from the merchant to review his/her product. In one embodiment, a user upon reviewing a product may broadly categorize the reviewed product exemplarily into “best product of this year”, “a fair product”, “an average fare”, “stay away from this product”, or the like.

Still referring to FIG. 1, each user entry is further associated with a plurality of merchant entries wherein, a merchant entry represents a participating online merchant who is being “followed” by the corresponding user. As a result of “following” a merchant, the user receives timely updates or notifications from the merchant such as, ads indicating new product arrivals, discounts, etc., on the main updates screen of the user. In one embodiment, the system 10 is adapted such that, only a predetermined number of updates from a merchant are updated on the main updates screen. Such a restricted merchant update is further associated with an exemplary “expand” button wherein, selecting the expand button directs the user to a supplementary updates screen where all the updates are listed thereon. In one embodiment, the user may selectively configure the system 10 such that, the updates from the merchant are displayed a predetermined number times, such as once or twice, after which, the merchant updates are moved to a dedicated exemplary merchant updates screen adapted to be opened by selecting an appropriate button. In one embodiment, the updates of the merchants who have paid a premium will be “featured”, i.e., will be given a priority to be displayed at the top of the main updates screen.

In one embodiment, each update from a merchant, whether on the main, supplementary or merchant updates screen, is associated with a “thumbs up” and a “thumbs down” button wherein, the user's selection of the thumbs up button indicates the user's appreciation of the corresponding update and the user's selection of the thumbs down button indicates the user's disapproval of the corresponding update. In one embodiment, each update, whether on the main or supplementary updates screen, is associated with a “comment” button wherein, the user selecting the comment button opens up a text input section where, the user is enabled to input generally his/her comments related to the corresponding update. In one embodiment, each comment posted by the user is associated with a “reply” button wherein, the merchant selecting the reply button opens up a text input section where, the merchant is enabled to input generally his/her comments related to the corresponding comment or comments. In one embodiment, each replied text is associated with a similar “reply” button so as to enable the merchant and the user to continue the conversations in the aforesaid manner. In one embodiment, each merchant update is associated with an exemplary “save” or “hide” button wherein, the user, upon selecting the save button, the corresponding merchant update is moved to an exemplary “my saved merchant updates” section for future reference.

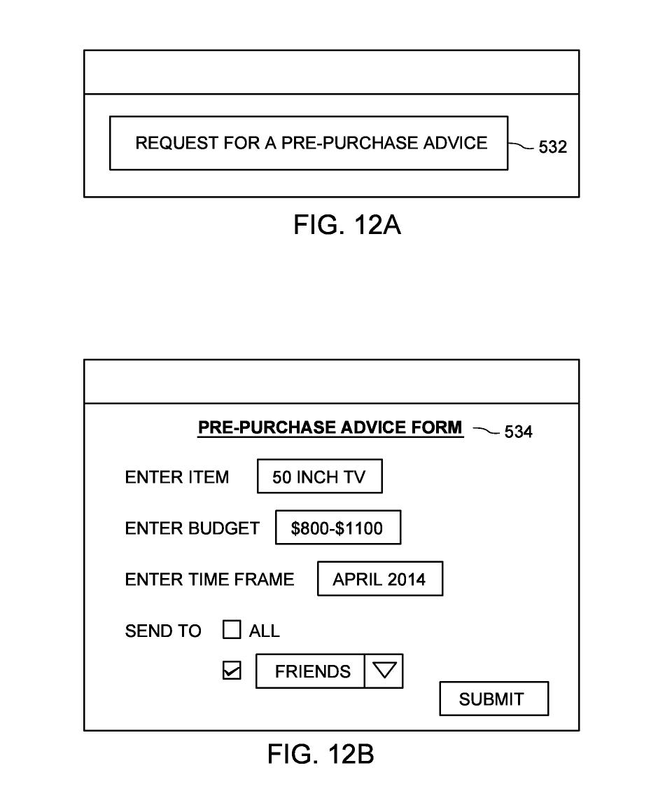

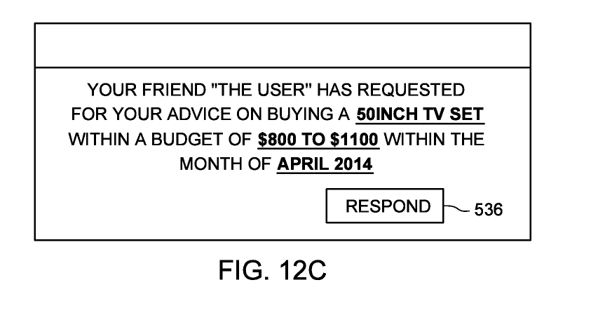

Referring to FIGS. 1, and 12A and 12B, the aforementioned pre-purchase advice module 53 comprises an exemplary “request a pre-purchase advice” button 532 wherein, the user, upon selecting the pre-purchase advice button 532, is directed to a pre-purchase form 534 where, the user is prompted to input the item or product he/she wants to purchase, the budget or the price range he/she is willing to allot to the product, and the time frame within which he/she wants to purchase the product. For example, the user might be interested in purchasing a 50-inch television within a budget of $800 to $1100 in the month of April, 2014. Once the product, budget and the time frame are defined by the user as seen in FIG. 12B, he/she is prompted to choose either all of his/her friends or a few friends to send the pre-purchase request. Each of the friends that received the pre-purchase advice request from the user in an exemplary format shown in FIG. 12C, responds by selecting the exemplary “respond” button 536 wherein, the selection of the respond button 536 directs a friend to a text input section (not shown) where he/she may input text, url, etc., pertaining to the subject. In one embodiment, as friends are selected by the user to send the pre-purchase request, the merchants that are followed by the user may also be selected user whereby, the merchant may respond directly with the product that match the user's purchase criteria.

Referring again to FIG. 1, the aforementioned fake account detection module 54 is adapted to weed out fake accounts created by users in order to fraudulently gain shopping incentives. The fake account detection module 54, in one embodiment, comprises an IP module for detecting the IP of the user, a match module for comparing the location of the generated IP and the location detail provided by the user in his/her profile. The fake account detection module 54 further comprises a termination module that terminates the account if there is a mismatch between the two locations. In another embodiment, when a user registers with the system 10, the fake account detection module 54 sends a validation request to the friends of the user prompting them to validate the user. In this embodiment, a termination module terminates the account if a predetermined number of responses are not received validating the user. In yet another embodiment, the fake account detection module 54 terminates an account if the account is inactive for a predetermined length of time. In still yet another embodiment, the fake account detection module 54 is adapted to periodically deliver a validation question wherein, the account is set to be terminated if the validation question is not replied within a predetermined length of time. In still yet another embodiment, if the user seeks to receive offers on X-rated or adult products, the fake account detection module 54 is adapted to prompt the user for a copy of drivers license or the like in order to validate his/her age. The fake account detection module 54 is adapted to terminate the account if either the copy of asked document is not provided within predetermined amount of time or if the age within the document doesn't match the regulatory age limit that is required for availing such products.

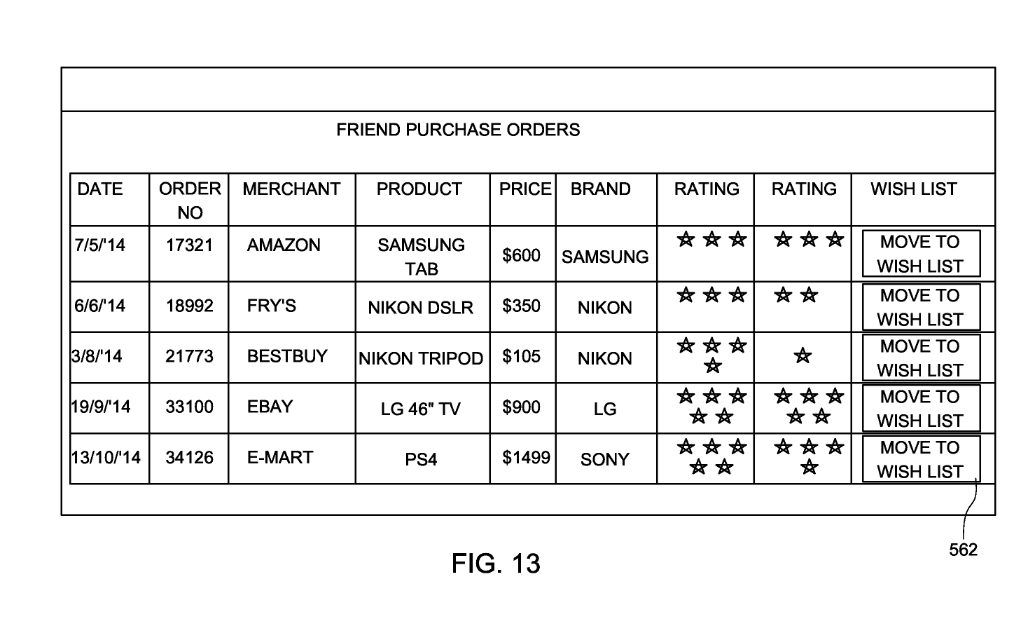

Referring to FIGS. 1 and 13, the aforementioned mentioned wishlist module 56 comprises an exemplary “add to my wishlist” or “move to wishlist” initiator associated with each of the friends' purchase order accessible by the user. More particularly, the exemplary “move to wishlist” initiator comprises an exemplary “move to wishlist” hyperlink 562 deployable by the user via the user interface 12. Upon the deployment of the “move to wishlist” hyperlink 562, the corresponding product is moved to a wishlist accessible the user for future references. In one embodiment, the wishlist adapted to be accessible by friends or select friends of the user. In one embodiment, a wishlist may be divided into a plurality of self-created sub-wishlists based on the occasion or events for which the user seeks to purchase the product in the wishlist. For example, the user may move a product to a sub-wishlist entitled “for my birthday” suggesting that the user wishes to procure corresponding wishlist item(s) for his/her birthday. In another example, the user may move a product to a sub-wishlist entitled “for my anniversary” suggesting that the user wishes to procure the corresponding wishlist item(s) for his/her anniversary. In one embodiment, a sub-wishlist is adapted to be accessible by friends or select friends of the user.

Referring to FIG. 1, the wishlist module 56 comprises a sub-wishlist notification module (not shown) for, before a predetermined time before the commencement of an event or occasion (say, 10 days before the event) , notifying the friends or select friends of the user of the corresponding sub-wishlist items the user wishes to procure or receive as a gift for the forthcoming event or occasion. In one embodiment, the sub-wishlist notification module comprises an anti-duplication module (not shown) for allowing friends to share information on already purchased items in order to avoid duplication of purchases.

In one embodiment, the wishlist module 56 comprises a contribution module (not shown) for enabling giftor user to collectively purchase a product for a giftee user wherein, the product could be a wishlist or sub-wishlist item. Notably, a giftor user comprises a user who gifts and a giftee user comprises a user who receives the gift. The contribution module comprises a monetary pocket where the contributions from the giftor users towards the product are collected through a conventional payment gateway. The contribution module further comprises a payment module for purchasing the product once the amount collected become equivalent to the purchase price of the product.

In one embodiment, the giftor users contributing may not necessarily be friends with one another as a giftor user, who is friend of the giftee user, for purposes of contributing for a product, may collaborate with the friends of the giftee user even though, as mentioned earlier, the giftor user is not friends with the other friends of the giftee user. In one embodiment, a giftor user is allowed to approach the friends of the giftee user upon the giftee user permitting the giftor user to do so. In one embodiment, the system is configured such that, a giftor doesn't have to know the profile details of the other giftor users in order to get in touch with them.

More particularly, if a giftor user seeks to gain access to the giftee user's friend list for the purposes of gathering other giftor users, the giftor user simply sends a request to giftee friend asking him/her to grant an access for the same. Once the access is granted, the giftor user now is able to communicate with the giftee user's friends for the purpose of discussing a certain event and/or for contributing in the aforementioned manner. In one embodiment, the giftee user, who was granted access to his/her friends list, is blocked from seeing what the giftor users are discussing such as, for example, what plans are being made for the giftee user's birthday or the like. In one embodiment, the system is configured such that, the giftee user may any time revoke the access granted by him/her to the giftor user. Upon the access being granted, the system is configured such that, a discussion board is created in order for the giftor users to communicate with one another. For example, the giftor users, who have the ability to access the giftee user's wishlist may also suggest additional gifting ideas on the discussion board whereby, additional gifts can instantly be added to the shopping cart for collective purchase. In one embodiment, a giftee or user may opt out of a purchase anytime.

For example, when John (giftor user) decides to give Mary (giftee user) a birthday gift, he might not be able to afford to buy it all by himself but with help of a few people (fellow giftor users) it can be afforded. John might also wonder that another Mary's friend might be making the same gift purchase and it would be important to collaborate with Mary's friends so that duplication doesn't happen. Lastly, John is wondering whether Mary actually has any gift preferences and if he can gain access to Mary's Wishlist so that the purchase has some meaning to Mary. John is ready to work on the problem, but he doesn't really know any of Mary's friends, or at least not all friends who Mary has on her friends list in her social networking accounts. Only Mary knows how many friends she has and who they are. John initially needs to send an alert request to Mary exemplarily as “Mary, I would like to be able to collaborate with your friends regarding your birthday, may I post to your friends please?” Upon Mary's consent, John is now granted an access to a virtual discussion board that allows him to collaborate with Mary's friends. John might initiate an exemplary message to all Mary's friends that “Mary's birthday is soon! Want to participate giving a gift?” In turn, this may initiate a discussion for all friends to collaborate what they want to purchase for Mary, and vote with their dollars on what they want to buy. Since Mary has ability to add items to her Wishlist, friends might request access to see it too. Notably, it is up to the friends to reveal their identities or remain anonymous when taking part in the gift giving discussion or contributing to its purchase.

The contribution module simply allows for a friend to get anonymous or an open access to Mary's friends so that all Mary's friends can participate in the purchase. Once discussion is started, various items can be added to a shopping list by all participating friends. Friends can also place full or partial orders for any of the items on the list. Once any particular item is paid for, all friends are now aware that the item is purchased to avoid any duplicate purchases. Additionally, participating friends can see other items that got only partial funding, and might need additional sources of funding before the purchase price is reached. All users are able to process payments electronically and commit to the payment of an item, so that once the total purchase price of the item is reached, the transaction is processed and everyone is aware of a completed purchase. Notably, Mary, before granting access to John to contact her friends, can restrict John to only certain friends on the list. In a similar manner, in one embodiment, a merchant may also act as John in initiating a contribution for Mary's gift. In any case, the once gifts are paid for, they are either shipped to the Mary or another indicated party, or a gift certificate is issued to Mary or the indicated party. In another example, in a similar manner, John can ask Mary to participate in the same discussion board for the purpose of planning a New Year's party, where all friends are jointly planning multiple purchases for the event, gifts, food and other party items. Some of the items might be paid online for, while others users can agree to pay for and bring themselves by purchasing it at a local store.

In one embodiment, the system 10 further comprises a parental module for detecting the users who are minors. Upon detection, the parental module is adapted to block certain topics or merchants when the user operates through the minor account. In one embodiment, the minor account (the account owned by a minor) is associated with a parent account if the parent is defined by in the minor account or if the parent has defined the minor account whereby, a parent is granted access to all the activities the minor has partaken in. Since minors are eligible to earn shopping incentives too, the parental module is adapted to allow parents to claim the incentives on behalf of the minors.

The present invention may include a discussion forum as an aid for user purchases. For example, if a user wants to go to a dentist, the user can avoid directly asking his friends and still find out what his friends recommend. The user can simply post a request in the discussion forum under an exemplary “Wanted” section and under an exemplary ‘services’ category or if appropriate, under an exemplary ‘goods’ category. The request may be “Looking for a Good Dentist, any recommendations?”. When user wants a new camera, the user can post in the exemplary goods category for example the exemplary “Wanted/Electronics Section”—“Need a new digital camera, any recommendations?” The friends of the user will see that their exemplary “wanted/goods” section is updated with a new request, provide the user with the requested a feedback where to go to get a dentist or shop. Each time any user makes a request, a discussion forum is created for all/each to contribute. Friends can contribute comments as well as post links through the discussion forums to relevant online stores that offer needed services/goods.

Users will also be able to review all previous forum discussions before creating a new one.

The aforementioned embodiments are able to be implemented, for example, using a machine-readable medium or article which is able to store an instruction or a set of instructions that, if executed by a machine, cause the machine to perform a method and/or operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions is able to include any suitable type of code, for example, source code, compiled code, interpreted code, executable code, static code, dynamic code, or the like, and is able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A shopper-centric social networking system comprising:
(a) a user interface;
(b) a user database comprising a plurality of user entries wherein, each user entry represents a user registered therewith, each user entry associated with a plurality of friend entries wherein, a friend entry represents a fellow registered user who is friends with the registered user as the personal profile of the fellow user is associated with that of the registered user, a registered user hereinafter referred to as a user, a fellow registered user, who is friends with the user hereinafter referred to as a friend, each user entry further associated with a plurality of purchase order entries wherein, a purchase order entry represents a purchase order placed by the user on a participating merchant site, a purchase order defined by a plurality of purchase order attributes comprising the date and time of purchase, the identity of the product purchased, the brand of the product purchased, the identity of the merchant site from which the product has been purchased, the product category of the product purchased; and
(c) a purchase orders settings module for enabling a user, via the user interface, to allow select friends thereof to access select purchase orders made by the user via the user interface.

2. The system of claim 1 adapted such that, the purchase orders are made accessible or inaccessible by the user to the friends thereof by product category or categories, the merchant or merchants from which the product has been purchased, the brand or brands of the product, and the price or the price ranges of the product.

3. The system of claim 1 adapted such that, the purchase orders are made accessible or inaccessible by the user to the friends thereof individually.

4. The system of claim 1 adapted such that, the purchase orders are made accessible or inaccessible by the user to select friends.

5. The system of claim 1 wherein, a friend's purchase order accessible by a user is associated with a sale request module comprising:
(a) a sale request initiator deployable by the user via the user interface;
(b) a sale request screen made accessible to the corresponding friend via the user interface upon the deployment of sale request initiator, the sale request screen soliciting the sale of corresponding product from the corresponding friend; and
(c) a price input screen for, upon consenting to the user's request for sale, inputting the selling price of the product;
wherein, the friend's acceptance or denial of the user's request for sale is communicated to the user and wherein, the selling price of the product is communicated to the user upon the friend's acceptance of the user's request for sale.

6. The system of claim 5 wherein, the sale request initiator comprises a sale request hyperlink.

7. The system of claim 5 wherein, the sale request screen comprises a comments input section for enabling the friend to input comments generally relating to the sale wherein, the comments are communicated to the user along with the friend's choice of acceptance or denial.

8. The system of claim 5 wherein, the sale request module further comprises an input field for enabling the user to input a proposal for a counter price to the friend in the event of the user declining the selling price asked by the friend; the input conveyed to the friend.

9. The system of claim 1 further comprises a purchase orders search module for enabling a user, via the user interface, to search for within the purchase orders of the friends thereof, the purchase orders search module comprising a retrieval module for retrieving the purchase order or orders that match the inputted keyword or keywords.

10. The system of claim 1 further comprises a main updates screen for displaying to the user, via the user interface, the recent purchase orders placed by the friends thereof.

11. The system of claim 10 wherein, on the main updates screen, the display of the number of purchase orders placed by a friend is adapted to be limited to a predetermined number.

12. The system of claim 11 further comprises a supplementary updates screen for displaying the total number of purchase orders that were earlier limited on the main updates screen.

13. The system of claim 12 further comprises an incentive module comprising:
(a) an calculation module for calculating the number of times the user has accessed a supplementary updates screen; and
(b) a generation module for generating a shopping incentive in keeping with the calculation performed by the calculation module.

14. The system of claim 13 wherein, the shopping incentive is transferrable.

15. The system of claim 12 wherein, the supplementary updates screen comprises a virtual game, the winner of which is awarded a shopping incentive.

16. The system of claim 1 wherein, the user database is disposed in operative communication with at least one merchant server so as to be updated with the purchase orders placed by the customers, who are the registered users; a merchant server pertaining to a merchant.

17. The system of claim 16 wherein, the at least one merchant server comprises a plurality of merchant servers.

18. The system of claim 16 wherein, the merchant comprises a virtual merchant.

19. The system of claim 16 wherein, the merchant comprises a physical merchant store.

20. The system of claim 1 adapted to award the user a virtual achievement display badge when the purchase orders made accessible by the user to the friends thereof amounts to or exceeds a predetermined monetary value.

21. The system of claim 1 adapted to award the user a virtual achievement display badge when the number purchase orders made accessible by the user to the friends thereof amounts to or exceeds a predetermined value.

22. The system of claim 1 adapted to award a user a shopping incentive if the total price of purchases pertaining to the purchase orders thereof that are made accessible to the friends thereof exceeds a predetermined price value.

23. The system of claim 22 wherein, the shopping incentive is transferrable.

24. The system of claim 1 adapted to award a user a shopping incentive if the total number of friends-accessible purchase orders thereof exceeds a predetermined number.

25. The system of claim 24 wherein, the shopping incentive is transferrable.

26. The system of claim 1 wherein, the plurality of purchase order attributes further comprises a transaction ID, which represents the transaction number that ties the corresponding product and the amount equivalent to the purchase price of the corresponding product that is debited from the user's credit card or bank account.

27. The system of claim 1 wherein, each user entry is associated with a plurality of merchant entries wherein, each merchant entry represents a participating merchant that is followed by the user.

28. The system of claim 27 adapted to deliver merchant updates to the user; the merchant updates being from the participating merchants, who are followed by the user.

29. The system of claim 28 wherein, a merchant update is adapted to be displayed a predetermined number of times.

30. The system of claim 29 wherein, a merchant updates after been displayed the predetermined number of times is moved to a dedicated, exemplary merchant updates screen accessible to by the user.

31. The system of claim 28 wherein, a merchant update comprises an advertisement indicating new product arrivals, discounts, etc.

32. The system of claim 28 wherein, a merchant update is given a display priority in exchange for a fee.

33. The system of claim 28 wherein, each merchant update is associated with an exemplary “save” button wherein, the user, upon selecting the save button, moves the corresponding merchant update to an exemplary “my saved merchant updates” section accessible by the user for future reference.

34. The system of claim 27 wherein, a merchant is enabled to approach a user for reviewing a product sold by the merchant.

35. The system of claim 1 further comprises a pre-purchase advice module comprising:
(a) an exemplary pre-purchase advice button;
(b) a pre-purchase advice form delivered to the user upon the deployment of the pre-purchase button, the pre-purchase form for receiving the item or product the user is interested in purchasing, a price range the user allotted for the product, and time frame within which the user wishes to purchase the product, the filled out form adapted to be delivered to one or more select friends selected by the user in a predefined format; and
(c) a text input field for enabling each of the select friends to input comments in response to the pre-purchase advice solicited by the user.

36. The system of claim 35 wherein, the information filled out by the user on the pre-purchase form is adapted to be delivered to one or more merchants selected by the user, a merchant representing a merchant site; each of the merchants, upon receiving the information, is enabled to respond to the user by inputting text within a text input field.

37. The system of claim 1 further comprises a product rating module comprising:
(a) an exemplary “rate the product” initiator associated with each of the user's purchase order, the exemplary “rate the product” deployable by the user via the user interface; and
(b) a product rating screen delivered to the user upon the deployment of the exemplary “rate the product” initiator, the product rating screen soliciting a rating from the user for the corresponding product.

38. The system of claim 37 wherein, the exemplary “rate the product” initiator comprises an exemplary “rate the product” hyperlink.

39. The system of claim 37 wherein, each product order is associated with the product rating awarded by the user, who has purchased the corresponding product.

40. The system of claim 37 wherein, the product rating screen further comprises an input field for enabling the user to input additional comments thereof regarding the corresponding product, the corresponding purchase order associated with the inputted additional comments.

41. The system of claim 37 wherein, the product rating module comprises a low product rating module for communicating to a corresponding product manufacturer a low rating awarded by the user to a product.

42. The system of claim 1 further comprises a merchant rating module comprising:
(a) an exemplary “rate the merchant” initiator associated with each of the user's purchase order, the exemplary “rate the merchant” deployable by the user via the user interface; and
(b) a merchant rating screen delivered to the user upon the deployment of the exemplary “rate the merchant” initiator, the merchant rating screen soliciting a rating from the user for the corresponding merchant.

43. The system of claim 42 wherein, the exemplary “rate the merchant” initiator comprises an exemplary “rate the merchant” hyperlink.

44. The system of claim 42 wherein, each product order is associated with the merchant rating awarded by the user, who has purchased from the corresponding merchant.

45. The system of claim 42 wherein, the merchant rating screen further comprises an input field for enabling the user to input additional comments thereof regarding the corresponding merchant, the corresponding purchase order associated with the inputted additional comments.

46. The system of claim 42 wherein, the merchant rating module comprises a low merchant rating module for communicating to a corresponding merchant a low rating awarded by the user thereto.

47. The system of claim 1 further comprising a wishlist module comprising an exemplary “add to my wishlist” initiator associated with each of the friends' purchase orders wherein, upon the deployment of the exemplary “add to my wishlist” initiator that associated with a friend's purchase order, the corresponding product is moved to a wishlist of the user.

48. The system of claim 47 wherein, the exemplary “add to my wishlist” initiator comprises an exemplary “add to my wishlist” hyperlink.

49. The system of claim 47 wherein, the wishlist is divided into a plurality of sub-wishlists, the division based on events such as birthday, anniversary, and the like, defined by the user.

50. The system of claim 49 wherein, the wishlist module comprises a sub-wishlist notification module for notifying the friends of the user of the sub-wishlist items of the user a predetermined time before the corresponding event.

51. The system of claim 50 wherein, the sub-wishlist notification module comprises anti-duplication module for allowing friends of the user to share information on already purchased items in order to avoid duplication of purchases.

52. The system of claim 49 further comprising a contribution module for enabling a plurality of giftor users to collectively purchase a product for a giftee user, a giftor user comprises a user who gifts and a giftee user comprises a user who receives the gift, the contribution module comprising:
(a) an exemplary “make a collective purchase” initiator deployable by a giftor user via the user interface thereof;
(b) a co-giftor selection screen for displaying the all the friends of the giftee user, each of the friends of the giftee user being selectable;
(c) a contribution requisition screen dispatched to one or more friends of the giftee user selected by the giftor user, the requisition screen comprising exemplary accept and reject buttons wherein, selecting the accept button indicates the friend's consent for the contribution and wherein, selecting the reject button indicates the friend's refusal for the contribution, a friend selecting the accept button treated as a giftor user;
(d) a monetary pocket for receiving contributions from the one or more giftor users towards at least one product; and
(e) a purchase module for purchasing the at least one product upon the contribution amount becoming equivalent to the price of the at least one product.

53. The system of claim 50 wherein, each of the at least one product comprises a sub-wishlist item.

54. The system of claim 53 wherein, in the event of the sub-wishlist item being one of at least two items within the sub-wishlist, the sub-wishlist item is selected by polling.

55. The system of claim 52 wherein, each of the one or more giftor users may not be friends with one another and therefore cannot access the profile details of one another.

56. The system of claim 52 wherein, the giftor user needs permission from the giftee user to direct the contribution requisition to the friends of the giftee user.

57. The system of claim 56 wherein, the giftee user, upon granting permission to communicate with a friend thereof, may revoke it anytime.

58. The system of claim 52 wherein, a giftee user is prevented from accessing the interactions between the giftor users.

59. The system of claim 49 wherein, a sub-wishlist is adapted to be accessible or inaccessible to select friends.

60. The system of claim 47 wherein, a wishlist is adapted to be accessible or inaccessible to select friends.

61. The system of claim 1 wherein, the system comprises an endorsement module comprising:
(a) an exemplary “endorse” initiator associated with each of the profile page of the friend;
(b) a product or service category screen displaying a plurality of product or service categories, the each of the category being selectable;
wherein, the user, upon selecting one or more categories on the category screen, the system is adapted to communicate to other friends of the user and the friends of the friend that the user has endorsed the friend as an expert in the product or service categories earlier selected by the user;

62. The system of claim 61 wherein, the “endorse” initiator comprises an “endorse” hyperlink.

63. A shopper-centric social networking system comprising:
(a) a user interface;
(b) a user database comprising a plurality of user entries wherein, each user entry represents a user registered therewith, each user entry associated with a plurality of friend entries wherein, a friend entry represents a fellow registered user who is friends with the registered user as the personal profile of the fellow user is associated with that of the registered user, a registered user hereinafter referred to as a user, a fellow registered user, who is friends with the user hereinafter referred to as a friend, each user entry further associated with a plurality of purchase order entries wherein, a purchase order entry represents a purchase order placed by the user on a merchant site, a purchase order defined by a plurality of purchase order attributes comprising the date and time of purchase, the identity of the product purchased, the brand of the product purchased, the identity of the merchant site from which the product has been purchased, the product category of the product purchased, the rating awarded by the user for the product, and the rating awarded by the user for the merchant from which the product has been purchased; and
(c) a purchase orders settings module for enabling a user, via the user interface, to allow select friends thereof to access select purchase orders made by the user via the user interface.
